(19) United States
(12) Patent Application Publication
(10) Pub. No.: US 2019/0318255 A1
(43) Pub. Date: Oct. 17, 2019

(54) Combining Entity Analysis and Predictive Analytics

(71) Applicant: FAIR ISAAC CORPORATION, Roseville, MN (US)

(72) Inventors: John R. Ripley, Austin, TX (US); Michael Betron, Austin, TX (US)

(21) Appl. No.: 16/109,547

(22) Filed: Aug. 22, 2018

Related U.S. Application Data
(60) Provisional application No. 62/657,318, filed on Apr. 13, 2018.

(51) Int. Cl. G06N 5/04; G06F 17/30

(52) U.S. Cl. CPC G06N 5/046; G06F 17/30011; G06F 17/30324; G06F 17/30598

(57) ABSTRACT

In an aspect, an entity group including associations of entities grouped according to a measure of similarity can be received. The entities can include units of data extracted from a set of documents. A vector can be assembled. Assembly of the vector can include evaluation of a predefined entity analytic using the received entity group. The vector can be provided to a second analytic. Related apparatus, systems, techniques, and articles are also described.

### CROSS-REFERENCE TO RELATED APPLICATIONS

This application claims priority to U.S. Provisional Application No. 62/657,318, filed on Apr. 13, 2018, the content of which is hereby expressly incorporated by reference herein in its entirety.

### TECHNICAL FIELD

The subject matter described herein relates to combining entity analysis and predictive analytics.

### BACKGROUND

Entity analytics (“EA”) can include a technology that can improve analytical decisions by understanding entities relative to their relationships with other entities within large sets of data. EA can be applied across data quality initiatives (e.g., cleansing, master data management) and other solutions that require identity hub directory services (information exchanges, application data management initiatives). EA can be applied to other applications.

### SUMMARY

In an aspect, an entity group including associations of entities grouped according to a measure of similarity can be received. The entities can include units of data extracted from a set of documents. A vector can be assembled. Assembly of the vector can include evaluation of a predefined entity analytic using the received entity group. The vector can be provided to a second analytic.

Non-transitory computer program products (i.e., physically embodied computer program products) are also described that store instructions, which when executed by one or more data processors of one or more computing systems, causes at least one data processor to perform operations herein. Similarly, computer systems are also described that may include one or more data processors and memory coupled to the one or more data processors. The memory may temporarily or permanently store instructions that cause at least one processor to perform one or more of the operations described herein. In addition, methods can be implemented by one or more data processors either within a single computing system or distributed among two or more computing systems. Such computing systems can be connected and can exchange data and/or commands or other instructions or the like via one or more connections, including a connection over a network (e.g. the Internet, a wireless wide area network, a local area network, a wide area network, a wired network, or the like), via a direct connection between one or more of the multiple computing systems, etc.

The details of one or more variations of the subject matter described herein are set forth in the accompanying drawings and the description below. Other features and advantages of the subject matter described herein will be apparent from the description and drawings, and from the claims.

### DESCRIPTION OF DRAWINGS

FIG. 1 is a flow diagram describing a process according to the current subject matter.

FIG. 2 is a process flow diagram illustrating an example data pipeline.

Like reference symbols in the various drawings indicate like elements.

### DETAILED DESCRIPTION

Predictive analytics and predictive models can rely on lower dimensionality data than is afforded by a complex multi-member entity (e.g., a piece of information such as a person, place, and/or thing). Such multi-member entities can include a collection of records relating to a place that, for example, can feature slight variations of the name of the place. In such a scenario, to make valid predictions and analytical conclusions about the place, typical predictive analytics and predictive models require attribution of all records to one unique place. By using entity analytics, the data can be simplified within these multi-member entities by assembling each of these records into entity groups (e.g., like entities that are related to one unique place) and distilling the entity groups into lower dimensionality data constructs (e.g., feature vectors). The feature vector can be conveyed for downstream model consumption and evaluation by predictive analytics, which return their insights. Additional analytics can consume the insights and other values for their analysis.

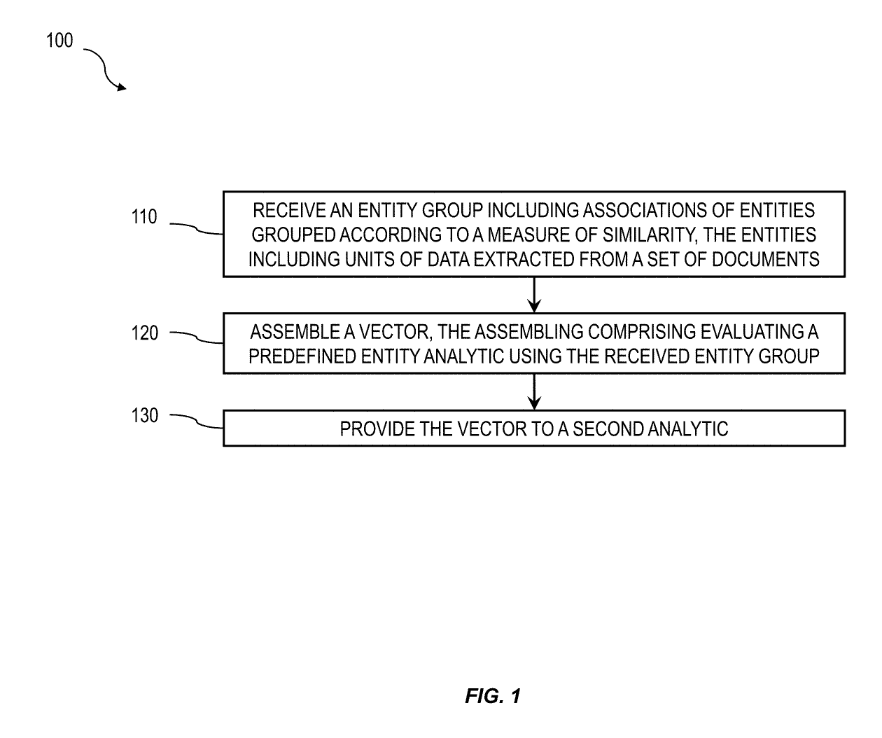

FIG. 1 is a process flow diagram illustrating an example process 100 of some implementations of the current subject matter that can provide for processing of entity groups into feature vectors suitable for use in one or more predictive, decision, or classification model.

At 110, an entity group can be received. An entity group can include a collection of similar entities that have been grouped based on various conditions and/or criteria using measures of similarity. An entity can include a single attribute (e.g. an identifier such as a name or Social Security Number) or it can include a complex object (e.g. address with street, city, state, and zip attribute or an entire person with name, address, dob, ssn attributes, and the like). The entities can include units of data extracted from a set of documents. A document can include a piece of uniquely identifiable structured or unstructured data. An example of such a document can be a report containing customer information. Entities can be extracted from documents, database records, or flat files for downstream processing and model evaluation. The collection of similar entities into entity groups can be referred to as clustering and it can use searching along with a set of similarity match conditions and thresholds to group these like entities. In some implementations, all entities in an entity group, members of the group, can be said to represent the same real-world thing, (in some instances with potentially slightly differing values for the entity attribute). In some implementations, the entity group can be received from an entity group assembler and passed to an entity group analyzer. In some implementations, the receiving of the entity group can be performed by at least one data processor forming part of at least one computing system.

At 120, a vector can be assembled. The vector can be a feature vector, and assembly of the vector can include evaluation of a predefined entity analytic using the received entity group. An entity analytic can include a process that takes in an entity group and emits a value suitable for a feature vector. According to an implementation, the pipeline can pass the assembled entity groups to an entity group analyzer that, using a set of entity analytics, can reduce the complexity of the entity group by processing the entity groups through the analytic to output a feature vector. In some implementations, the evaluation of the predefined entity analytic can include executing the predefined entity analytic with the received entity group to compute a vector value, which can include a feature. For example, the predefined entity analytic can include a count, a sum, a standard deviation, a distinct, an external query, a complex logic script, a time-series analytic, a time-window analytic, or a source document analytic that results in a feature value. In some implementations, the predefined entity analytic can calculate a feature using logic. The logic can include a count, a sum, a standard deviation, a distinct, an external query, a complex logic script, a time-series analytic, a time-window analytic, or a source document analytic. In some implementations, the vector can include multiple features. The vector can include a set of values, which can be numeric or boolean in nature (although other types are contemplated) that have been derived from a set of entity analytics. Each feature can include one or more values generated by the evaluation of the predefined entity analytic using the entity group. In some implementations, the entity group analyzer can assemble the vector. In some implementations, the assembling of the vector can be performed by at least one data processor forming part of at least one computing system.

At 130, the vector can be provided to a second analytic. In some implementations, the second analytic can be evaluated using the vector as an input to the second analytic to form an output. In some implementations, the second analytic can be a model. The feature vector can be evaluated against one or more predictive, decision, or classification models; the result of which can be a prediction, a decision, or a classification, respectively. In some implementations, the second analytic can include a predictive analytic configured to generate electronic data corresponding to a predictive output, a decision analytic configured to provide electronic data corresponding to a decision generated by applying one or more rules to the vector, or a descriptive analytic. The descriptive analytic can be configured to perform operations that can include selecting a rule set to apply to the vector, to the entity group, or to both, by accessing a stored collection of rule sets, generating a classification of the vector or the entity group based on at least the rule set, and providing electronic data corresponding to the classification. In some implementations, the entity group analyzer can provide the vector to the second analytic. In some implementations, the providing of the vector to the second analytic can be performed by at least one data processor forming part of at least one computing system.

In some implementations, process 100 can include extracting an entity from a document. In other implementations, process 100 can include assembling at least one record source into a document. In other implementations, process 100 can include extracting the entities from the set of documents, persisting the entities in an entity store, persisting the documents in a document store, assembling the entities into the entity group and evaluating the second analytic using the vector.

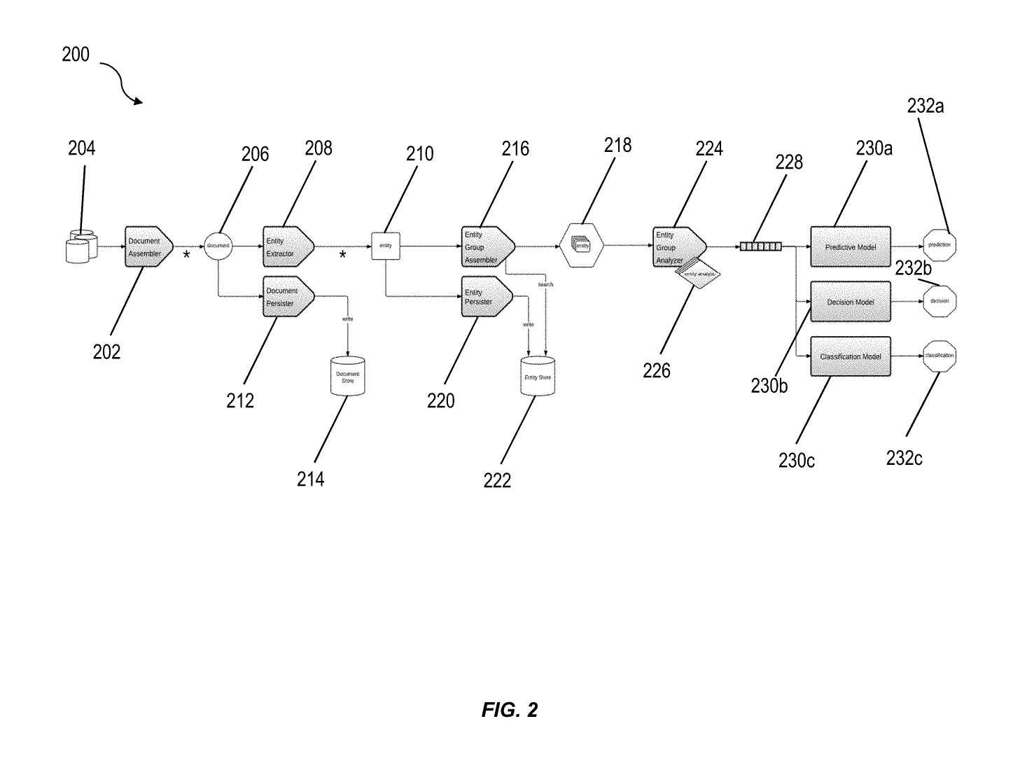

FIG. 2 is a block diagram illustrating an example processing pipeline capable of processing of an entity for use with predictive analytics. The processing pipeline can include a data pipeline 200 featuring a document assembler 202. The document assembler 202 can select records in their native form. In some implementations, records can be sourced from a relational database 204, a non-structured query language (“NoSQL”) database, and/or files from a file system. The document assembler 202 can assemble the records from various sources into at least one document 206. The at least one document 206 can be passed to an entity extractor 208, wherein at least one entity 210 can be extracted from the at least one document 206. For example, the entity extractor 208 can identify and extract a “Phone number” entity from a document, or extract a “Person” entity from a claim. In addition, the at least one document 206 can be passed to a document persister 212, which can be configured to write the at least one document to a document store 214. Extraction can be achieved, for example, utilizing field level mappings on structured documents, natural language processing, text analytics on unstructured data, and the like. In some implementations, documents 206 can be transformed into extracted entities 210 of a particular type. In some implementations, the entity extractor 208 can extract no entities from the at least one document 206.

The extracted entities 210 can be passed to an entity group assembler 216, which can group extracted entities 210 with like entities to form entity groups 218. The entity group assembler 216 can aggregate all entities 210 (e.g., that have been extracted from all the documents, which have been assembled from all the source) that represent the same thing or real world object (despite data anomalies) into an entity group 218. Other implementations are possible. In an example implementation, a clustering process can be utilized, which can be achieved by running similarity/fuzzy searches against the entities to identify potential candidates and using a set of “conditions” to filter the candidates down to entity group members. Other implementations can include using MapReduce, which can also perform this task. The extracted entities 210 can also be passed to an entity persister 220, which can be configured to write the extracted entities 210 to an entity store 222. The entity group assembler 216 can also query the entity store 222 for previously-identified like entities that represent the same thing or real world object for inclusion into the entity group 218 by the entity group assembler 216.

The entity group 218 can be passed to an entity group analyzer 224, which can apply a configurable set of at least one entity analytic 226 to the entity group 218 (the collection of entities that represent the same thing) and can emit a feature vector 228. Each entity analytic 226 can be responsible for generating a number of features to be added to the feature vector 228.

This feature vector can then be input into at least one predictive model 230a, at least one decision model 230b, or at least one classification model 230c, the output of which is a prediction 232a, a decision 232b, or a classification 232c. From the example above and as a further example: a predictive model, through training, may predict that this person is not likely to commit a certain kind of claims fraud; a decision model may decide, through rules, that a person with >1 SSN is subject to further review; and a classification model may classify this person as an “employee” and “policy holder”.

Consider the example below. A “Person” entity has been defined as an object that has a Name, Address, Date Of Birth, and SSN. A Person entity can be extracted from various document types in an organization. In the case below, there are 3 Person entities, extracted from 2 Auto Claim and 1 human resources documents and grouped together as the “same” person due to the similarities.
Person Entity Group
   Entity
      Source=Claim—34446
      Name=John Ripleshaw
      Address
         Street=123 Main Street
         City=Austin
         State=TX
         ZIP=78729
      DOB=1/24/1975
      SSN=123121234
   Entity
      Source=Claim—77754
      Name=John Ripleshaw
      Address
         Street=123 Main St
         City=Austin
         State=TX
         ZIP=78729
      DOB=1/24/1975
      SSN=789787890
   Entity
      Source=HR—334
      Name=John Ripleshaw
      Address
         Street=123 Main St
         City=Austin
         State=TN
         ZIP=78729
      DOB=1/24/1975
      SSN=123121234

Now consider a set of analytics that have been defined that capture the following features: number of unique SSNs; whether an employee; and number of claims. For this record, the example set of analytics would yield a feature vector of: [2,1,2].

The current subject matter provides many technical advantages. For example, as illustrated by the above example, some implementations of the current subject matter can take a complex entity group having significant variation and can distill that complex entity group into at least one feature that is suitable for model processing.

This combination of entity analytics and predictive analytics may be achieved in a variety of ways and may be enhanced with a many additional or alternative features.

The subject matter described herein provides many advantages. For example, the current subject matter can provide improved modeling capacity, speed, and efficiency by providing computerized functionality for simplifying data into a form that can be more readily analyzed by models. This improvement can provide a technical solution that allows for analytical information to be generated from the raw data with little or no pre-preparation of the raw data prior to analysis. Some aspects of the current subject matter enable an improved predictive system in that analysis can be performed faster and/or with fewer computing resources. In some implementations, new capabilities are provided enabling predictive modeling and analysis that some existing systems cannot provide.

Although a few variations have been described in detail above, other modifications or additions are possible. For example, in some implementations, entity analytics can perform counts, sums, averages, standard deviations, distincts, other aggregates, and the like. In some implementations, entity analytics can query external AOI (e.g., to determine whether a person is on TSA no fly list). In some implementations, entity analytics can calculate a feature using logic. The logic can include a count, a sum, a standard deviation, a distinct, an external query, a complex logic script, a time-series analytic, a time-window analytic, or a source document analytic. In some implementations, entity analytics can perform complex scripted logic. In some implementations, predictive, decision, or classification models can be located in-process or remote via Application Programming Interfaces (APIs). In some implementations, one or multiple predictive analytics passes (subsequent passes build upon previous results) can be performed. In some implementations, entity analytics can act on time-series or time-windows. In some implementations, entity analytics can act not only on the entities but also on their source documents.

In some implementations, the current subject matter can perform real-time analysis where documents are updated and grouping and analysis is ongoing.

The current subject matter can be applied to a broad range of applications. For example, the current subject matter can be applied to fraud detection and fraudulent identity detection. Other example applications include customer relationship management (CRM), collections, anti-money laundering, marketing, underwriting, and the like.

The subject matter described herein provides many technical advantages. For example, some implementations of the current subject matter obviates need for manual review (tedious, daunting, and in many cases intractable). Some implementations of the current subject matter can enable examining the entity group, which gives a 360-degree view of the entity as opposed to first-order metrics examining aspects of individual documents. Some implementations of the current subject matter can enable document analysis without manual interpretation (e.g., doesn't require manual review). Some implementations of the subject matter can enable near real-time detection of unusual activity based on application of entity characteristics against a predictive model.

One or more aspects or features of the subject matter described herein can be realized in digital electronic circuitry, integrated circuitry, specially designed application specific integrated circuits (ASICs), field programmable gate arrays (FPGAs) computer hardware, firmware, software, and/or combinations thereof. These various aspects or features can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device. The programmable system or computing system may include clients and servers. A client and server are generally remote from each other and typically interact through a communication network. The relationship of client and server arises by virtue of computer programs running on the respective computers and having a client-server relationship to each other.

These computer programs, which can also be referred to as programs, software, software applications, applications, components, or code, include machine instructions for a programmable processor, and can be implemented in a high-level procedural language, an object-oriented programming language, a functional programming language, a logical programming language, and/or in assembly/machine language. As used herein, the term “machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal. The term “machine-readable signal” refers to any signal used to provide machine instructions and/or data to a programmable processor. The machine-readable medium can store such machine instructions non-transitorily, such as for example as would a non-transient solid-state memory or a magnetic hard drive or any equivalent storage medium. The machine-readable medium can alternatively or additionally store such machine instructions in a transient manner, such as for example as would a processor cache or other random access memory associated with one or more physical processor cores.

To provide for interaction with a user, one or more aspects or features of the subject matter described herein can be implemented on a computer having a display device, such as for example a cathode ray tube (CRT) or a liquid crystal display (LCD) or a light emitting diode (LED) monitor for displaying information to the user and a keyboard and a pointing device, such as for example a mouse or a trackball, by which the user may provide input to the computer. Other kinds of devices can be used to provide for interaction with a user as well. For example, feedback provided to the user can be any form of sensory feedback, such as for example visual feedback, auditory feedback, or tactile feedback; and input from the user may be received in any form, including acoustic, speech, or tactile input. Other possible input devices include touch screens or other touch-sensitive devices such as single or multi-point resistive or capacitive trackpads, voice recognition hardware and software, optical scanners, optical pointers, digital image capture devices and associated interpretation software, and the like.

In the descriptions above and in the claims, phrases such as “at least one of” or “one or more of” may occur followed by a conjunctive list of elements or features. The term “and/or” may also occur in a list of two or more elements or features. Unless otherwise implicitly or explicitly contradicted by the context in which it is used, such a phrase is intended to mean any of the listed elements or features individually or any of the recited elements or features in combination with any of the other recited elements or features. For example, the phrases “at least one of A and B;” “one or more of A and B;” and “A and/or B” are each intended to mean “A alone, B alone, or A and B together.” A similar interpretation is also intended for lists including three or more items. For example, the phrases “at least one of A, B, and C;” “one or more of A, B, and C;” and “A, B, and/or C” are each intended to mean “A alone, B alone, C alone, A and B together, A and C together, B and C together, or A and B and C together.” In addition, use of the term “based on,” above and in the claims is intended to mean, “based at least in part on,” such that an unrecited feature or element is also permissible.

The subject matter described herein can be embodied in systems, apparatus, methods, and/or articles depending on the desired configuration. The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and subcombinations of the disclosed features and/or combinations and subcombinations of several further features disclosed above. In addition, the logic flows depicted in the accompanying figures and/or described herein do not necessarily require the particular order shown, or sequential order, to achieve desirable results. Other implementations may be within the scope of the following claims.

What is claimed is:

1. A method comprising:
receiving an entity group including associations of entities grouped according to a measure of similarity, the entities including units of data extracted from a set of documents;
assembling a vector, the assembling comprising evaluating a predefined entity analytic using the received entity group; and
providing the vector to a second analytic.

2. The method of claim 1, further comprising evaluating the second analytic using the vector as an input to the second analytic to form an output.

3. The method of claim 1, wherein the vector includes features, the features including a set of values generated by the evaluation of the predefined entity analytic using the entity group.

4. The method of claim 1, wherein evaluating the predefined entity analytic includes executing the predefined entity analytic with the received entity group to compute a vector value.

5. The method of claim 1, wherein the predefined entity analytic includes a count, a sum, a standard deviation, a distinct, an external query, a complex logic script, a time-series analytic, a time-window analytic, or a source document analytic.

6. The method of claim 1, wherein the second analytic includes:
a predictive analytic configured to generate electronic data corresponding to a predictive output;
a decision analytic configured to provide electronic data corresponding to a decision generated by applying one or more rules to the vector; or
a descriptive analytic configured to perform operations comprising
selecting a rule set to apply to the vector, to the entity group, or to both, by accessing a stored collection of rule sets;
generating a classification of the vector or the entity group based on at least the rule set; and
providing electronic data corresponding to the classification.

7. The method of claim 1, further comprising extracting an entity from a document.

8. The method of claim 1, further comprising assembling at least one record comprising at least one entity from at least one record source into a document.

9. The method of claim 1, wherein the receiving is by an entity group analyzer and from an entity group assembler; the assembling of the vector is using the entity group analyzer; and the providing the vector to the second analytic is performed by the entity group analyzer.

10. The method of claim 9, wherein the receiving, the assembling, and the providing is performed by at least one data processor forming part of at least one computing system.

11. The method of claim 1, further comprising:
extracting the entities from the set of documents;
persisting the entities in an entity store;
persisting the documents in a document store;
assembling the entities into the entity group; and
evaluating the second analytic using the vector;
wherein the second analytic includes:
a predictive analytic configured to generate electronic data corresponding to a predictive output;
a decision analytic configured to provide electronic data corresponding to a decision generated by applying one or more rules to the vector; or
a descriptive analytic configured to perform operations comprising
selecting a rule set to apply to the vector, to the entity group, or to both, by accessing a stored collection of rule sets;
generating a classification of the vector or the entity group based on at least the rule set; and
providing electronic data corresponding to the classification.

12. The method of claim 1, wherein the predefined entity analytic calculates a feature using logic, the logic including a count, a sum, a standard deviation, a distinct, an external query, a complex logic script, a time-series analytic, a time-window analytic, or a source document analytic.

13. A system comprising:
at least one data processor; and
memory storing instructions configured to cause the at least one data processor to perform operations comprising:
receiving an entity group including associations of entities grouped according to a measure of similarity, the entities including units of data extracted from a set of documents;
assembling a vector, the assembling comprising evaluating a predefined entity analytic using the received entity group; and
providing the vector to a second analytic.

14. The system of claim 13, the operations further comprising evaluating the second analytic using the vector as an input to the second analytic to form an output.

15. The system of claim 13, wherein the vector includes features, the features including a set of values generated by the evaluation of the predefined entity analytic using the entity group.

16. The system of claim 13, wherein evaluating the predefined entity analytic includes executing the predefined entity analytic with the received entity group to compute a vector value.

17. The system of claim 13, wherein the predefined entity analytic includes a count, a sum, a standard deviation, a distinct, an external query, a complex logic script, a time-series analytic, a time-window analytic, or a source document analytic.

18. The system of claim 13, wherein the second analytic includes:
a predictive analytic configured to generate electronic data corresponding to a predictive output;
a decision analytic configured to provide electronic data corresponding to a decision generated by applying one or more rules to the vector; or
a descriptive analytic configured to perform operations comprising
selecting a rule set to apply to the vector, to the entity group, or to both, by accessing a stored collection of rule sets;
generating a classification of the vector or the entity group based on at least the rule set; and
providing electronic data corresponding to the classification.

19. The system of claim 13, the operations further comprising extracting an entity from a document.

20. A non-transitory computer program product storing instructions which, when executed by at least one data processor forming part of at least one computing system, cause the at least one data processor to implement operations comprising:
receiving an entity group including associations of entities grouped according to a measure of similarity, the entities including units of data extracted from a set of documents;
assembling a vector, the assembling comprising evaluating a predefined entity analytic using the received entity group; and
providing the vector to a second analytic.
